(19) United States
(12) Patent Application Publication
(10) Pub. No.: US 2023/0071035 A1
(43) Pub. Date: Mar. 9, 2023

(54) Toasting Accessory

(71) Applicant: Chad Orebaugh, Liberty Lake, WA (US)

(72) Inventor: Chad Orebaugh, Liberty Lake, WA (US)

(21) Appl. No.: 17/466,023

(22) Filed: Sep. 3, 2021

(51) Int. Cl. A47J 37/06

(52) U.S. Cl. CPC A47J 37/0664

(57) ABSTRACT

The following invention relates to a novel cooking container to complement use of conventional toasters, ovens and other cooking appliances. Specifically this unique invention pertains to a device that utilizes high temperature resistant material to enclose food items. With the food securely held, place into a conventional bread toaster for re-heating, cooking and toasting. This device allows a new method for preparation of favorite meals and snacks such as sandwiches with cheese and meat, desserts with graham crackers, marshmallows and chocolate. This unique concept prevents the contents from spilling out into the cooking appliance and encloses the contents in a compact and neat package. The device washed then re-used, single use low cost disposable units utilize much less material and are disposed after a single use.

### CROSS REFERENCE TO RELATED APPLICATIONS

Not Applicable.

### REGARDING FEDERALLY SPONSORED RESEARCH AND DEVELOPMENT

Not Applicable.

### REGARDING SEQUENCE LISTING

Not Applicable.

### BACKGROUND OF THE INVENTION

The present invention relates to a novel cooking container to compliment the conventional oven, bread toaster and other cooking appliances. Specifically this unique container utilizes high temperature resistant material to allow the normal cooking temperatures associated with cooking appliances. Historically many dishes suited only for open flame or saucepan cooking now achieved through other appliance methods. The device contains and holds the food securely in any orientation. It holds the contents secure ensuring that no contact of the contacts is possible to the heating element of the cooking appliance. The container placed into a conventional cooking device such as a bread toaster. The contents toasted, baked or re-heated. The device washed then re-used, single use low cost disposable units utilize much less material and are disposed after a single use.

Toasting bread, preparing grilled cheese sandwiches and roasting marshmallows oven an open fire are well known. Rapid and effective re-heating of pizza is also very common with the use of microwaves and ovens that take time to pre heat.

The use of this container allow a very rapid method of both preparing and cooking but also facilitates the ability to reheat food items such as pizza in a rapid and effective method all while retaining the necessary crunch and crisp that a traditional toaster over offers.

As a result the container can now be used to prepare otherwise consuming meals such as a grilled cheese sandwich or a smore′ (graham cracker, marshmallow and chocolate) without the need for an open flame or saucepan.

The container can be designed many sizes and shapes sizes. These sizes can be accommodated to match a specific food of choice for easy distinction on its use, pizza shape, bread shape, smore′ shape, tater tots shape, french fry shape and so on.

The container consists of two halves that snap together to form an enclosed box to ensure that the container remains closed while in use.

The container has applications for both re-usable version with sufficient cross sections and structural integrity for multiple uses and cleaning. A disposable version also applicable that eliminates the ability to wash and withstand multiple heat cycles in a toaster.

The container after use can easily be dis-assembled allowing normal hand washing or washing in a typical dishwashing machine.

The application of this device also employs the ability to have openings on the side of the part to allow natural heat to enter the cavity of the enclosed box while in use.

While many applications have similarities to this novel idea, none of which employs sufficient structural means supporting many food types and styles, deliberately focused on specific types of foods and desserts.

Reference Cited U.S. Pat. No. 11,006,783 Morales. This prior art suffers the limitation only for circular shaped foods for use.

The listed prior art suffer many limitations, potential of overheating and fires, the inability for automated dishwashing.

Prior art also does not have the ability to be secure tight containing the contents.

Reference Cited U.S. Pat. No. 10,610,053, Masterson

The listed prior art is a combustible apparatus, not for use indoors due to ventilation.

Reference Cited U.S. Pat. No. 10,398,259 Hetherington

The listed prior art suffer many limitations, inability to use indoors, contents are not secure from falling off apparatus.

Reference Cited U.S. Pat. No. 8,505,444 McGuigan

The listed prior art suffers the complexity of a system inclusive of toaster rotisserie and toasting elements.

In addition the entire prior art does not have the ability to hold the contents secure while toasting. The present invention utilizes common household equipment without the need for additional fuels or devices.

### BRIEF SUMMARY OF THE INVENTION

This summary provided to communicate the design of the toasting accessory in a simplified format, then fully defined in the detailed section of the invention. This brief summary is not intended to limit and key characteristics or primary critical aspects of the claimed subject.

The current invention has a simple single piece enclosure half that allow two of a common part to assemble creating a six sided box enclosure. Each half consisting of pockets for placement of food contents. Each half has roasting standoffs or vents to allow efficient penetration of heat while cooking. Each half includes symmetrical keying features that allow ease of assembly of the device when closed.

The device produced in many different sizes, shapes, colors and materials. Each of those materials capable of high heat toasting environments as well as safe for washing in standard household environments, dishwashers, soap and water and is resistant to normal detergents for cleaning. The material if food grade safe.

### BRIEF DESCRIPTION OF THE SEVERAL VIEWS OF THE DRAWING

The previous summary in combination with the detailed description of the invention is more adequately defined and comprehended when read in combination with the illustrations. The purposed of the drawings and illustrations are to indicate the embodiments of the invention but not to limit the specific methods and construction contained in them.

FIG. 1 illustrates a front perspective view of the encompassment of the present invention.

FIG. 2 illustrates a back perspective view of the encompassment of the present invention.

FIG. 3 illustrates an open front perspective view of the encompassment of the present invention.

FIG. 4 illustrates an open back perspective view of the encompassment of the present invention.

FIG. 5 illustrates a right view of the encompassment of the present invention.

FIG. 6 illustrates a top view of the encompassment of the present invention.

FIG. 7 illustrates a front view of the encompassment of the present invention.

FIG. 8 illustrates an open exploded perspective view of the encompassment.

FIG. 9 illustrates a detailed exploded perspective view of the encompassment of the present invention illustrating the hinge feature details.

FIG. 10 illustrates a perspective section view of the encompassment of the present invention at the hinge and latch interface of the device.

FIG. 11 illustrates a detailed section view of the encompassment of the present invention illustrating the latch of the device.

FIG. 12 illustrates a detailed section view of the encompassment of the present invention illustrating the hinge of the device.

### DETAILED DESCRIPTION OF THE INVENTION

In further description of the figures described prior, the numerical reference designators have been indicated to provide the reader and additional comprehension in the following. The included figures and representations are simply provided to describe one or more methods and configurations of this invention.

Some specific processes, materials and combinations of the current invention and use are illustrated and prescribed that all of these items modified without intentional modification of the patent described within.

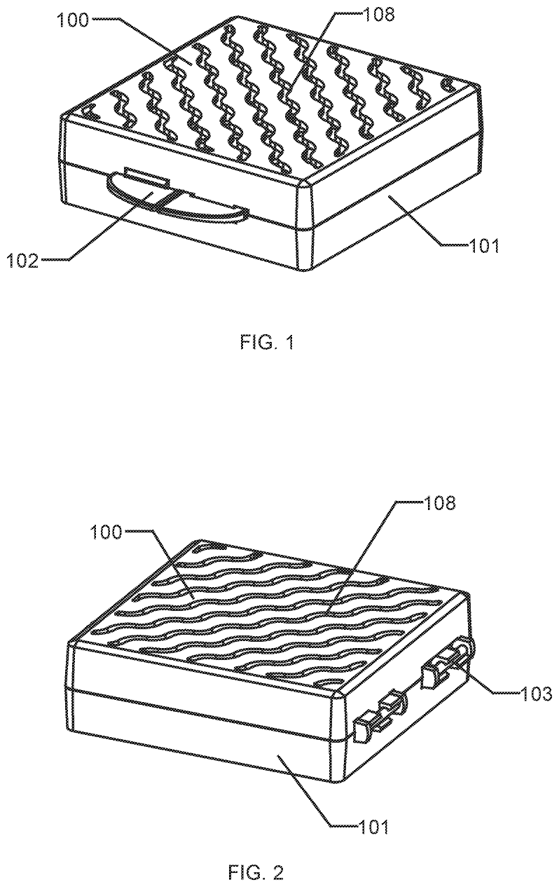

FIG. 1 indicates the top enclosure 100 attached to the bottom enclosure 101 from a front perspective illustrating the symmetrical latch feature 102. The top enclosure 100 and bottom enclosure 101 differentiated only in the drawing for clarity. The actual part is the same only assembled with opposing surfaces. The vents in the 100 top enclosure 108 allows heat to enter the device.

FIG. 2 indicates the top enclosure 100 attached to the bottom enclosure 101 from a back perspective illustrating the symmetrical hinge feature 103. The vents in the 101 bottom enclosure 108 allows heat to enter the device.

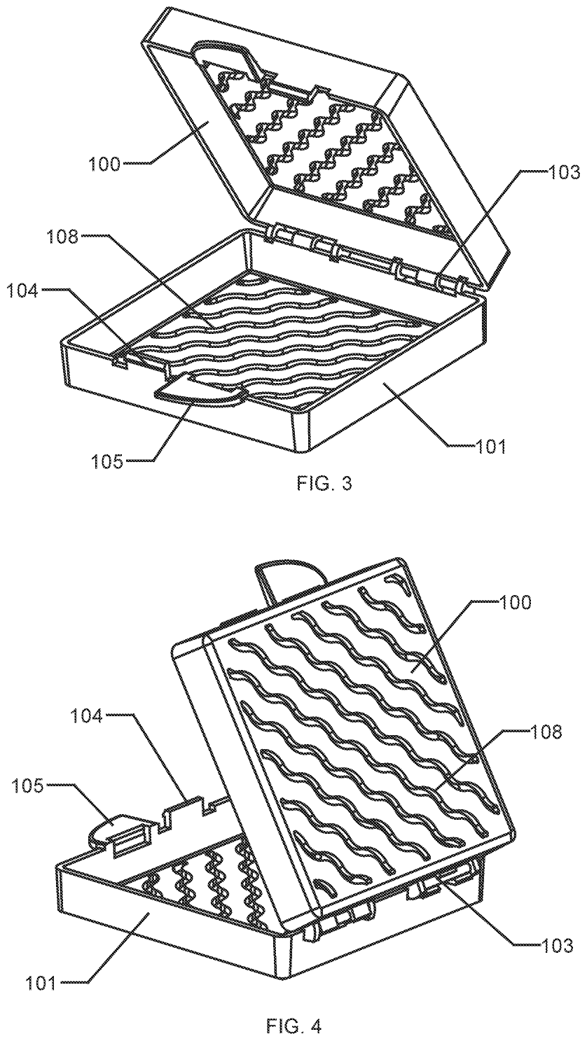

FIG. 3 indicates the front open view of the assembled top enclosure 100 and bottom enclosure 101. Further detailed in FIG. 3 are two of the opposing unassembled snap latches with the positive portion illustrated by item 104 and the negative portion illustrated as item 105. Further illustrated in figure three is the open angle of the top enclosure 100 relative to the bottom enclosure 101 that can vary between zero degrees (closed) and 180 degrees (open). FIG. 3 also illustrates the assembled hinge detail 103. Additionally the 101 bottom enclosure inside vents indicated by item 108.

FIG. 4 indicates the back open view of the assembled top enclosure 100 and bottom enclosure 101. Further detailed in FIG. 3 are two of the opposing unassembled snap latches with the positive portion illustrated by item 104 and the negative portion illustrated as item 105. Further illustrated in figure three is the open angle of the top enclosure 100 relative to the bottom enclosure 101 that can vary between zero degrees (closed) and 180 degrees (open). FIG. 3 also illustrates the assembled hinge detail 103. Additionally the 100 top enclosure outside vents indicated by item 108.

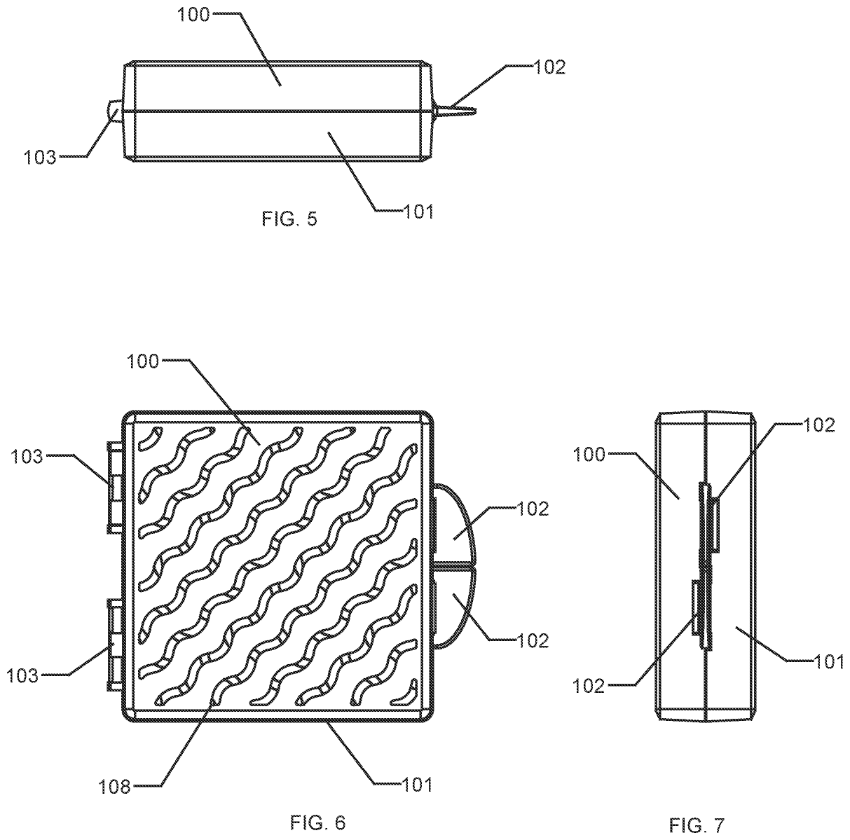

FIG. 5 shows the right view of the assembled top enclosure 100 and bottom enclosure 101. Further detailed in FIG. 5 are the closed opposing snap latches 102 and the closed hinges 103.

FIG. 6 shows the top view of the assembled top enclosure 100 and bottom enclosure 101. Further detailed in FIG. 6 are the closed opposing snap latches 102 and the closed hinges 103. The top enclosure 100 vents indicated by item 108 allowing heat to enter the device.

FIG. 7 shows the front view of the assembled top enclosure 100 and bottom enclosure 101. Further detailed in FIG. 7 are the closed opposing snap latches 102.

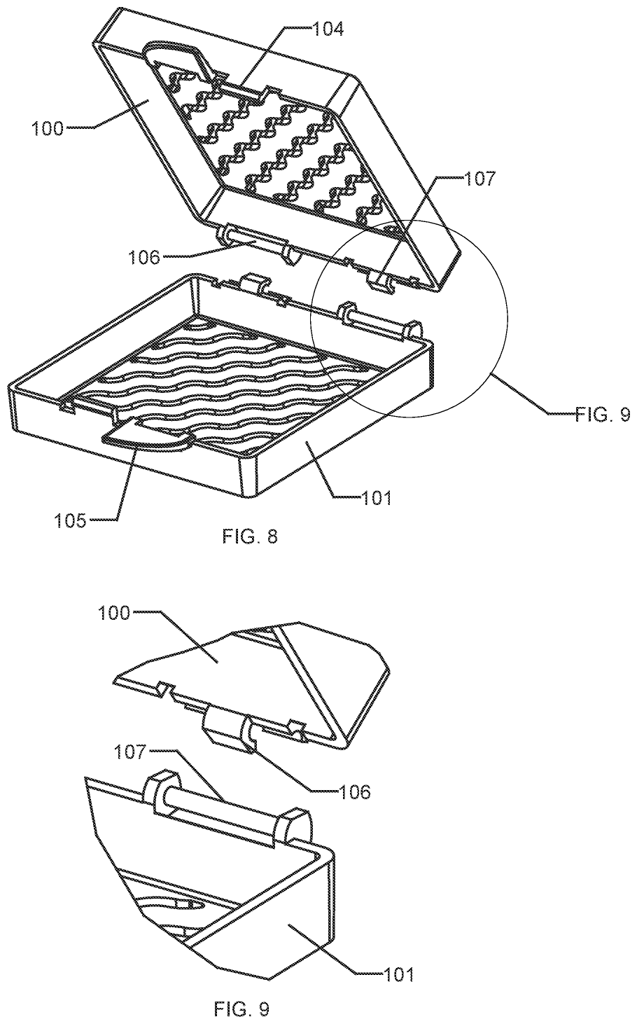

FIG. 8 illustrates an open exploded perspective view of the encompassment indicating the top enclosure 100 unassembled from the bottom enclosure 101. Further detailed in FIG. 8 are the unassembled hinge details with the positive portion shown by item 106 and the negative portion shown by item 107. FIG. 8 further illustrates the positive latch 104 unassembled from the negative latch 105.

FIG. 9 further details the open exploded perspective view of the encompassment indicating the top enclosure 100 unassembled from the bottom enclosure 101. Further detailed in FIG. 9 are the unassembled hinge details with the positive portion shown by item 106 and the negative portion shown by item 107.

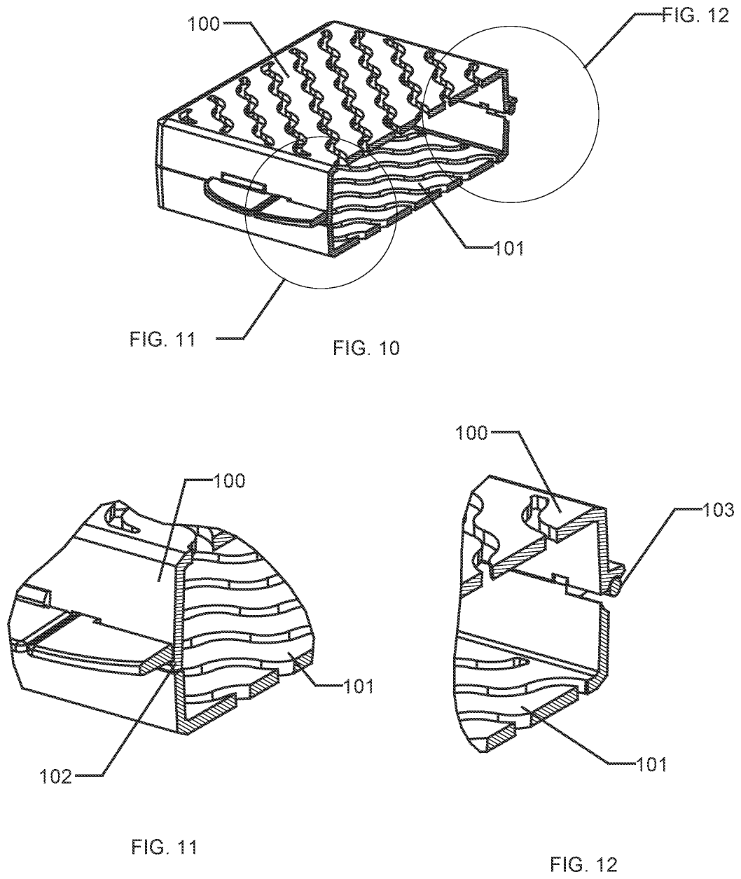

FIG. 10 illustrates a closed sectioned perspective view of the encompassment indicating the top enclosure 100 assembled to the bottom enclosure 101.

FIG. 11 further details the closed section perspective view of the encompassment indicating the top enclosure 100 assembled to the bottom enclosure 101. Further detailed in FIG. 11 is the closed latch 102.

FIG. 12 further details the closed section perspective view of the encompassment indicating the top enclosure 100 assembled to the bottom enclosure 101. Further detailed in FIG. 11 is the closed hinge 103.

1. Toaster oven accessory device for cooking s′mores in a toaster, consisting of a uniform flat front enclosure and uniform flat back enclosure where said enclosures are common and attached front to back with snap latch features. The said enclosures lay flat open for assembly, then one placed on top of the other and snapped shut before use. The front and back enclosures are parallel separated by air space when shut. The front and back enclosures include sidewalls creating a box with one large open side. Included are flanged perimeter that include snap latches on the sides, making the part universal and symmetric.

2. The device of claim 1 adapted to hold at least one s′more assembly, graham cracker top, chocolate, marshmallow and gram cracker bottom.

3. The device of claim 1 adapted to hold at least one slice of pizza.

4. The device of claim 1 adapted to hold at least one grilled cheese sandwich, bread and cheese.

5. The device of claim 1 adapted to hold a plethora of french fries.

6. The device of claim 1 adapted to hold a plethora of tater tots.

7. The device of claim 1 adapted to hold a variety of foods for toasting, cooking and reheating.

5. The device of claim 1 wherein the enclosure front and back comprised of a heat resistant material.

4. The device of claim 1, wherein the enclosure snapped together.

5. The device of claim 1, wherein each side has a mechanical locking feature.

6. The device of claim 1 wherein said enclosures are made of a heat resistant polymer, thermoset, thermoplastic or silicone.

7. The device of claim 1, wherein the toaster is a pop-up toaster.

8. The device of claim 1, wherein the toaster is a tabletop toaster, built in oven or convection over.

9. The device of claim 1, wherein the enclosures are disposable.

10. The device of claim 1, wherein the enclosures are re-usable.

11. The device of claim 1, wherein the enclosures are dishwasher safe.
